(19) United States
(12) Patent Application Publication
(10) Pub. No.: US 2018/0253433 A1
(43) Pub. Date: Sep. 6, 2018

(54) JOB APPLICATION REDISTRIBUTION

(71) Applicant: Microsoft Technology Licensing, LLC, Redmond, WA (US)

(72) Inventors: Fedor Vladimirovich Borisyuk, Sunnyvale, CA (US); Liang Zhang, Fremont, CA (US); Krishnaram Kenthapadi, Sunnyvale, CA (US)

(21) Appl. No.: 15/827,768

(22) Filed: Nov. 30, 2017

Related U.S. Application Data
(60) Provisional application No. 62/465,950, filed on Mar. 2, 2017.

(51) Int. Cl. G06F 17/30; G06Q 50/00

(52) U.S. Cl. CPC G06F 17/3053; G06Q 50/01; G06F 17/30035; G06F 17/30899

(57) ABSTRACT

A system, a computer-readable medium comprising instructions, and a computer-implemented method are directed to a Forecasting Engine, as described herein. The Forecasting Engine receives a ranked list of content portions that are ranked based on relevance score values of the content portions. Each relevance score value is indicative of a measure of similarity between a member account of a social network service and a content portion. The Forecasting Engine forecasts an expected number of member account actions resulting from presentation of a content portion included in the ranked list to a member account. The Forecasting Engine modifies the relevance score value of the content portion based on the expected number of member account actions. The Forecasting Engine updates the ranked list based on a modified relevance score value of the content portion. The Forecasting Engine generates and causes a display of a user interface that presents the updated ranked list.

### CROSS-REFERENCE TO RELATED APPLICATIONS

This application claims the benefit of priority to U.S. Provisional Patent Application entitled “JOB APPLICATION REDISTRIBUTION”, Ser. No. 62/465,950, filed Mar. 2, 2017, which is hereby incorporated herein by reference in its entirety.

### TECHNICAL FIELD

The subject matter disclosed herein generally relates to the technical field of special-purpose machines that forecast member account behavior including software-configured computerized variants of such special-purpose machines and improvements to such variants, and to the technologies by which such special-purpose machines become improved compared to other special-purpose machines that forecast member account behavior.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may, specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with an example embodiment;

FIG. 2 is a block diagram showing functional components of a professional social network within a networked system, in accordance with an example embodiment;

FIG. 3 is a block diagram showing example components of a Forecasting Engine, according to some embodiments.

FIG. 4 is a block diagram showing a system architecture for data flow in a Forecasting Engine, according to example embodiments;

FIG. 5 is a flowchart illustrating an example method, according to various embodiments;

FIG. is a block diagram of an example computer system on which operations, actions and methodologies described herein may be executed, in accordance with an example embodiment.

### DETAILED DESCRIPTION

The present disclosure describes methods and systems for forecasting member account behaviour in a professional social networking service (also referred to herein as a “professional social network,” “social network” or a “social network service”). In the following description, for purposes of explanation, numerous specific details are set forth in order to provide a thorough understanding of the various aspects of different embodiments of the subject matter described herein. It will be evident, however, to one skilled in the art, that the subject matter described herein may be practiced without all of the specific details.

A system, a machine-readable storage medium comprising instructions, and one or more operations of a computer-implemented method are directed to a Forecasting Engine as described herein. The Forecasting Engine improves the performance of a special-purpose computer system by efficiently predicting a number of presentation impressions for each portion of content such that a desired number of member account responses are received. Such presentation of content (e.g., impressions) is provided to one or more member accounts in a social network system that may include millions of member accounts and millions of various types of content.

The Forecasting Engine receives a ranked list of content portions. The content portions are ranked based on respective relevance score values associated with the content portions. Each relevance score value is indicative of a measure of similarity between a member account of a social network service and a content portion. The Forecasting Engine forecasts an expected number of member account actions resulting from presentation of a content portion included in the ranked list to a given member account (e.g., in a user interface displayed on a client device associated with the member of the given member account). The Forecasting Engine modifies the relevance score value of the content portion based on the expected number of member account actions. The Forecasting Engine updates the ranked list of content portions based on a modified relevance score value of the content portion. The updating of the ranked list of content portions results in an updated ranked list of content portions. The Forecasting Engine generates and causes a display of a user interface on a client device. The user interface presents (e.g., displays) the updated ranked list of content portions.

In some example embodiments, each content portion can be a job post submitted to a social network service from a member account representative of an organization. A job post is a description of a job vacancy at the organization. Each job post has one or more profile attributes describing a job title, a job summary, a required level of education, a required level of professional experience, a geographic region identifier, or additional attributes based at least on attribute types from profile data described herein.

According to various embodiments, a social network service provides a functionality for member accounts to submit applications fur one or more job posts uploaded to the social network service. Some job posts receive more applications from member accounts than other job posts. Receiving too many job applications may not be desirable since a job poster (e.g., a member account that activates a job post in the social network service) may not want to have to sort through numerous applications to identify quality job candidate. Receiving too few received job applications may also not be desirable since a job poster may want a baseline number (e.g., target number) of received job applications to ensure that the job post itself has attracted enough quality job candidates from which to choose. The Forecasting Engine described herein determines a forecast of an expected number of applications a job post will receive. Based on the job poses application forecast, the Forecasting Engine can modify the job post's relevance score value where such modified relevance score value will affect how often and to which member accounts the job post is displayed throughout the social network service.

According to an embodiment of the Forecasting Engine, a job post is detected as becoming available on the social network service for viewing by member accounts and for receipt of job application submissions. The job post is available for a pre-defined time window (e.g. 1 week, 30 days, 50 days). The Forecasting Engine calculates an applications forecast for the job post when it has been available during a portion of the time window (e.g. the first 48 hours). The applications forecast is based at least on member account behaviors associated with the job post and job post attributes. Such member account behaviors are, for example, member account views, which are random impressions to member accounts happening at a certain rate over time, and a number of job applications already received.

An impression of a job post occurs when it is presented in a jobs listing to a member account. It is understood that a jobs listing can be different for each member account and a particular job post can be included in one or more of the different jobs listings. Inclusion of the job post is based on a score value (e.g. relevance score value) that is indicative of (e.g., represents) a probability that the member account will apply to the job post. As such, a machine learning algorithm can be executed to score the job post relevance with respect to each member account. The relevance score value is determined by the Forecasting Engine using one or more machine learning algorithms based on attributes of the job post (e.g. job post features) and attributes of the member account (e.g. member account features). Job post attributes can be a geographic location, a job title, required job skills, required job education, a company, or a functional role. Member account attributes can be any type of profile data.

Those job posts that have score values that meet (e.g., are equal to) or exceed a relevance score threshold value are included in a jobs listing for display to the member account. A job post's placement in the jobs listing is modified in response to the applications forecast determined by the Forecasting Engine. A job post with an application forecast that exceeds a target range (e.g., number) of applications is penalized by the Forecasting Engine and deemed less relevant so as to suppress the number of actual applications received. A job post with an application forecast that falls below the target range of applications is boosted by the Forecasting Engine and deemed more relevant so as to induce an increase in the number of actual applications received. In it understood that the target range of applications can be unique to each job post or the same for each job post.

A job post's applications forecast is calculated by the Forecasting Engine to determine whether to penalize or boost that job post. The Forecasting Engine calculates each job post's applications forecast according to Imp*ctr, where Imp represents an number of impressions for the job post and ctr represents a probability of a respective member account submitting an application to that job post. The Forecasting Engine calculates Imp by determining a sum (T) of each day in the time window. For purposes of calculating T, the Forecasting Engine utilizes a constant rate of impressions per day for determining an impression count for each day in the time window (e.g. Day₁, Day₂, Day₃ . . . Dayₓ in an x day time window). While impression count for each day is constant, any particular day can be compressed to count as less time in order to create an impression rate adjustment of the constant rate. For example, Saturdays and Sundays will be counted as 12 hours instead of 24 hours, Mondays and Tuesday will be counted as 24 hours, Wednesdays will be counted as 20 hours, Thursdays counted as 18 hours and Fridays as 16 hours. Such impression rate adjustments account for the reality that member accounts show an overall change in interest in job posts on different days of the week.

In addition, an exponential decay rate is applied to each day in the time window (e.g. Day₁, Day₂, Day₃ . . . Dayₓ in an x day time window). The decay rate accounts for the reality that newer jobs are more interesting to member accounts than older jobs. As such Day₁, Day₂, and Day₃ will each have a smaller decay rate of impressions than Dayₓ₋₂, Dayₓ₋₁ and Dayₓ. As such, T is the result of a summation of an average number of impressions in each day in the x day time window—with the impression count, impression rate adjustment and decay rate applied on a per-clay basis. It is understood that the average impression count can be based on an average count of impressions per day for previous job posts, an average count of impressions per day for previous job posts in a particular job industry, or an average count of impressions per day for previous job posts from a particular organization. The decay rate of impressions is based on behaviors of member accounts with respect to previous job posts.

Imp is thereby determined by the Forecasting Engine according to Imp=T/(t+r)*(Vₜ+r*gamma). As discussed above, T is the impression count sum for each day in the time window. in addition, t represents the summation of the job post's impression count for those days that have already occurred, where t is calculated in a similar manner as T, but limited to those days that have already passed. Vₜ represents the actual number impressions the job post has received. The variable r represents a sample amount of time (such as 4 hours, 5 hours, 10 hours, etc.). The variable gamma represents an average number of impressions for previous job posts have received during the sample amount of time (e.g., r).

The Forecasting Engine calculates ctr according to ctr=(Ct+S*gamma)/(Vₜ+S). The variable Ct represents a current count of applications received by a given job post. The variable S represents a control parameter than can be tuned (e.g., updated). The Forecasting Engine multiplies Imp and ctr (e.g., Imp*ctr) to generate an applications forecast for a job post.

The Forecasting Engine compares the applications forecast to confidence interval range (e.g., number) of average applications per job post. If the applications forecast exceeds the confidence interval range, the Forecasting Engine penalizes the job post. If the applications forecast is below the confidence interval range, the Forecasting Engine boosts the job post. To penalize the job post, the Forecasting Engine calculates an exponent for the job post's relevance score value. The exponent is generated by dividing the number of applications received by the job post by alpha, where alpha is control parameter that can be tuned to adjust decay harshness. By applying the exponent to the relevance score value, the relevance score value of the job post is lowered, thereby effecting how often that job post will appear in job listings for member accounts. With fewer job listing appearances, the number of actual application received will be lower than the forecasted number of applications. To boost a job post, the Forecasting Engine increases the job post's relevance score value b a pre-defined percentage (e.g. 5%), thereby effecting how often that job post will appear in job listings for member accounts. With increased job listing appearances, the number of actual application received will be higher than the forecasted number of applications.

Various example embodiments further include encoded instructions that comprise operations to generate a user interface(s) and various user interface elements. The user interface and the various user interface elements can be representative of any of the operations, data, job posts, member accounts, ranked listings of job posts, time windows, and forecasted number of applications as described herein. The user interface and various user interface elements are generated by the Forecasting Engine for display on a computing device, a server computing device, a mobile computing device, etc.

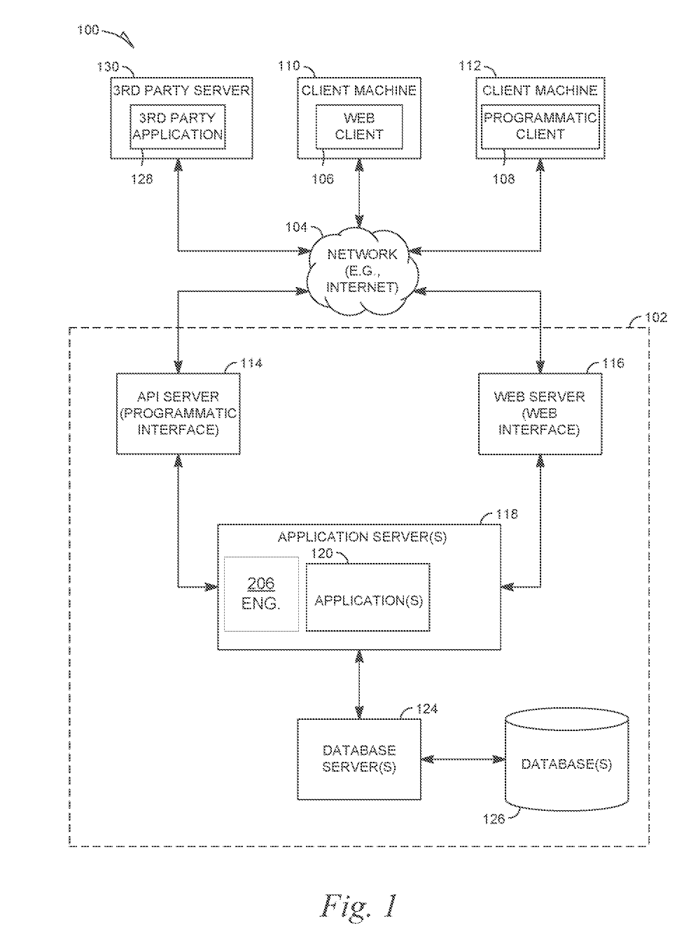

Turning now to FIG. 1, FIG. 1 is a block diagram illustrating a client-server system, in accordance with an example embodiment, A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked. system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 1116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 1102. In some embodiments, the networked system 102 may comprise functional components of a professional social network.

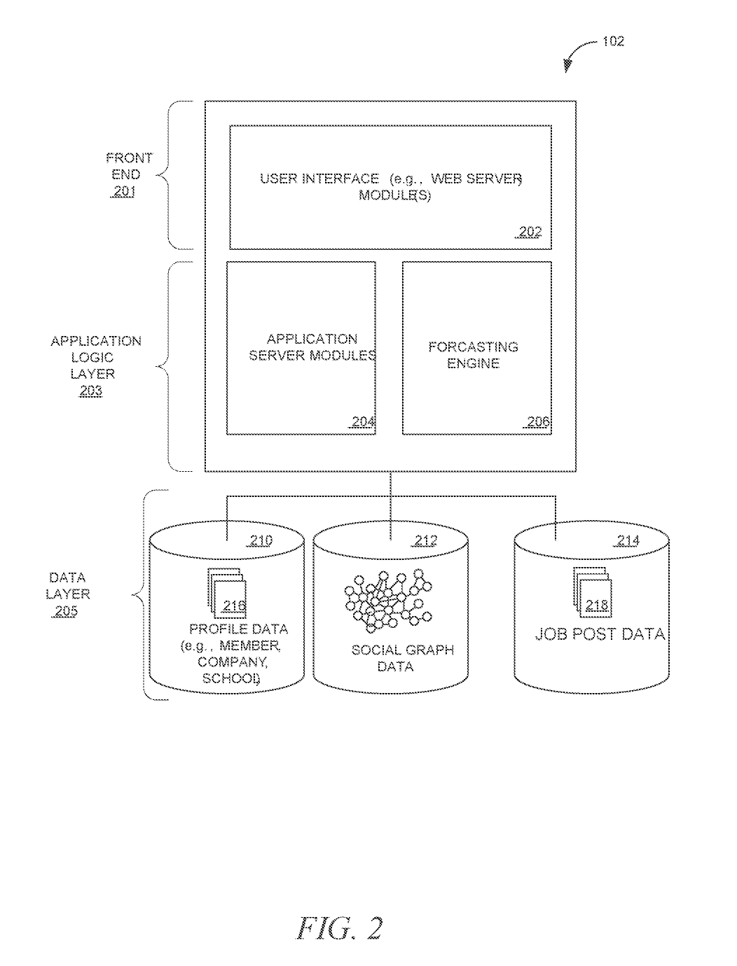

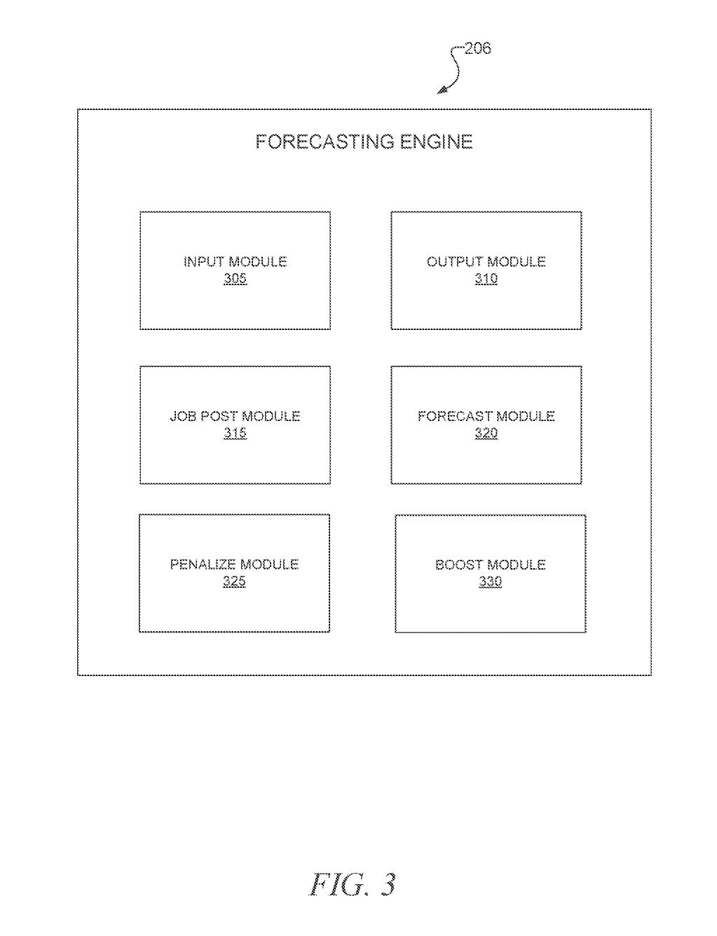

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a professional social network, such as that illustrated in FIG. 2, to facilitate additional functionality that is not specifically described herein. Furthermore, the various functional modules and engines depicted in FIG. 2 may reside on a single server computer, or may be distributed across several server computers in various arrangements. Moreover, although a professional social network is depicted in FIG. 2 as a three-tiered. architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface modules) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

in some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

The data in the data layer 205 may be accessed, used, and adjusted. by the Forecasting Engine 206 as will be described in more detail below in conjunction with FIGS. 3-5. Although the Forecasting Engine 205 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure. In some example embodiments, the data layer 205 further includes a database 214 that includes job post data 218 based on one or more job posts and data representative of behaviours of one or more member accounts with respect to one or more current and previous job posts.

FIG. 3 is a block diagram showing example components of a Forecasting Engine 206, according to some embodiments.

The input module 305 is a hardware-implemented module that controls, manages and stores information related to any inputs from one or more components of system 102 as illustrated in FIG. 1 and FIG. 2. In various embodiments, the inputs include any type of data required for calculation of Imp=T/(t+r)*(Vₜ+r*gamma) and ctr=(Ct+S*gamma)/(Vₜ+S) as described herein. In addition, the inputs include one or more member accounts and one or more job posts.

The output module 310 is a hardware-implemented module that controls, manages and stores information related to any outputs to one or more components of system 100 of FIG. 1 (e.g., one or more client devices 110, 112, third party server 130, etc.). In some embodiments, the output is a modified relevance score value of one or more job posts. In addition, the output is a listing of job posts, where each job post is ranked according to respective relevance score values.

The job post module 315 is a hardware-implemented module which manages, controls, stores, and accesses information related to storing job posts. In some example embodiments, each job post and corresponding job post data attributes are stored in a job post database accessed by the job post module 315.

The forecast module 320 is a hardware-implemented module which manages, controls, stores, and accesses information related to generating a job applications forecast for one or more job posts. In some example embodiments, the forecast module 320 executes generating of job applications forecast for one or more job posts.

The penalize module 325 is a hardware-implemented module which manages, controls, stores, and accesses information related to penalizing a job post by modifying (e.g., decreasing, lowering, etc.) a relevance score value of one or more job posts.

The boost module 330 is a hardware-implemented module which manages, controls, stores, and accesses information related to boosting a job post by modifying (e.g., increasing) a relevance score value of one or more job posts.

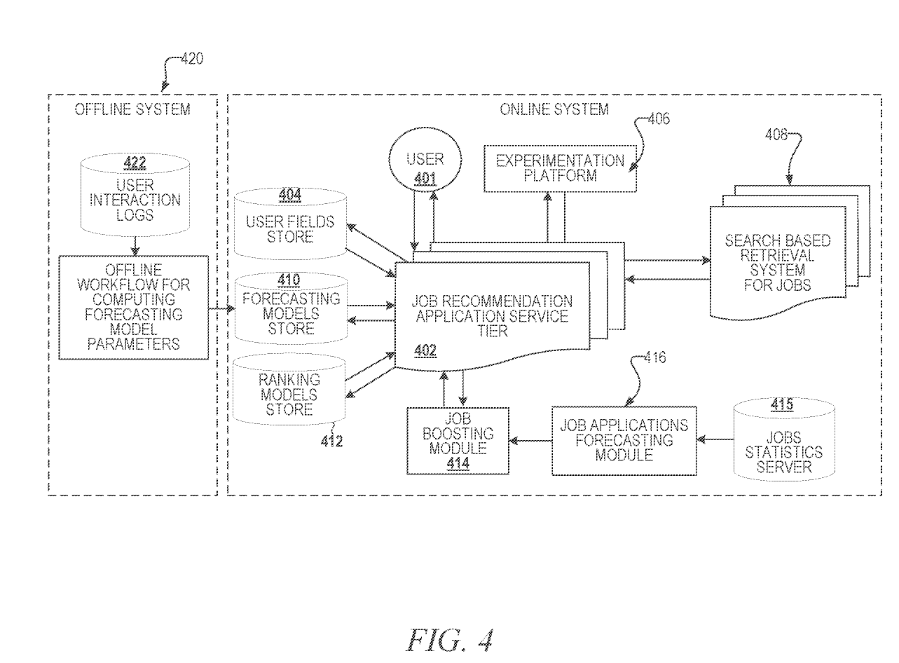

FIG. 4 is a block diagram showing a system architecture for data flow in a Forecasting Engine 206, according to example embodiments.

FIG. 4 illustrates an overall data flow of how a query is processed according to an exemplary system architecture of the Forecasting Engine 206. A client application of the social network service receives a query from a member account and forwards the query to a backend job recommendation application service tier 402. In some example embodiments, the query represents a member identifier that corresponds to (e.g., corresponds with, or is associated with) the member account 401.

The job recommendation application service tier 402 prepares data necessary to retrieve job recommendations for the member account 401 associated with the query. The job recommendation application service tier 402 retrieves profile data of the member account 401 from a database 210 (which includes storage of profile data of the member account) and determines an experimental testing data model identified by the experimentation platform 406. In some example embodiments, the user fields store 404 is part of the database 210. A particular experimental testing data model corresponds to a member account segment to which the member account 401 (that corresponds to the received query) belongs. Each experimental testing model includes a different methodology with respect to calculating relevance score values as between a given job post and a particular member account and for ranking job posts for display to the particular member account. Such instructions for executing the calculations of the various different methodologies are stored in the forecasting models store 410 and the ranking model store 412. Each experimental testing model is associated with a type of member account segment such that different scoring and ranking methodologies are used on a per-member-account-segment basis. It is understood that the forecasting model store 410 includes instructions for calculating candidate job post selection according to one or more jobs forecasting models and the ranking model store 412 includes instructions for calculating ranking of the relevance score values according to one or more ranking models.

The job recommendation application service tier 402 communicates with a search based retrieval system 408 to receive a listing of job posts for recommendation to the member account. The search based retrieval system 408 executes candidate job post selection and ranking of relevance score values of the job posts. In some example embodiments, ranking of the relevance score values is performed according to a Generalized Linear Mixed function. Ranked results are passed back to the job recommendation service application tier 402.

Upon receiving the ranked results, the job recommendation service application tier communicates with a job boosting module 414. The job boosting module 414 calls a forecasting module 416 to predict the job applications that each job post in the ranked results will receive during an upcoming time window (such as the upcoming 30 days). The forecasting module 416 calls a job statistics server 418, which includes storage of real-time statistics about job posts, such as the number of impressions, views and selection (e.g. clicks) each job post has received. Such statistics can be used to generate input data for calculating Imp=T/(t+r)*(Vₜ+r*gamma) and ctr=(Ct+S*gamma)/(Vₜ+S). Based on the statistics provided by the job statistics server 418, the forecasting module 416 predicts the number of applications each job post is going to receive by the end of the time window, which is usually 30 days.

Using the predicted number of job applications from the forecasting module 416, and based on a configured confidence interval, the job boosting module 414 executes boosting or decaying of the relevance score values of the job posts. The job boosting module 414 returns an updated listing of job posts based on one or more modified relevance score values to the job recommendation application service tier 402. The job recommendation application service tier 402 returns the updated listing of job posts back to a client application for display (e.g., in a user interface on a client device).

The Forecasting Engine 206 includes an offline data flow of an offline system 420 that can be implemented in a Hadoop distributed environment and uses R-statistical packages for experimentation and parameters estimation. The offline data flow accesses user interaction log data stored in logs store 422, which includes job impressions and apply clicks to estimate parameters of the statistical models used in the forecasting.

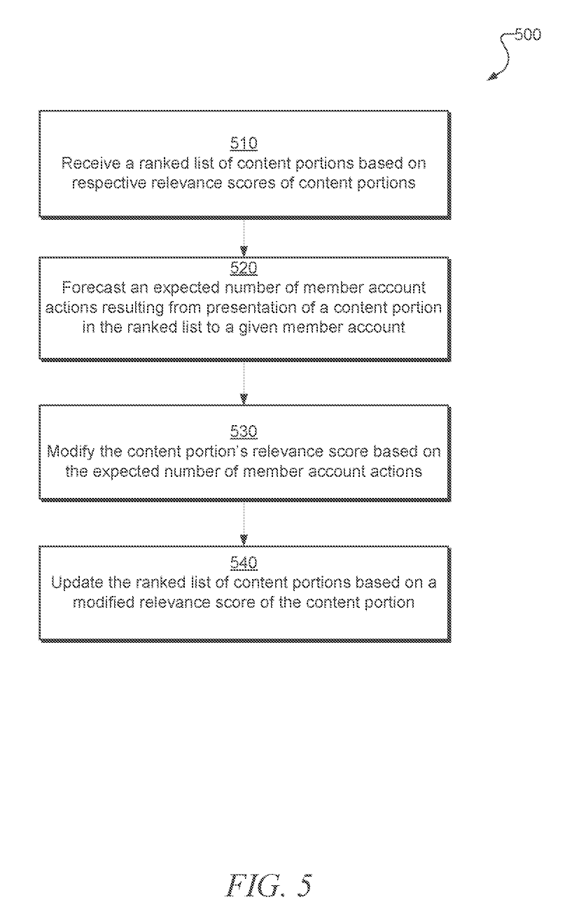

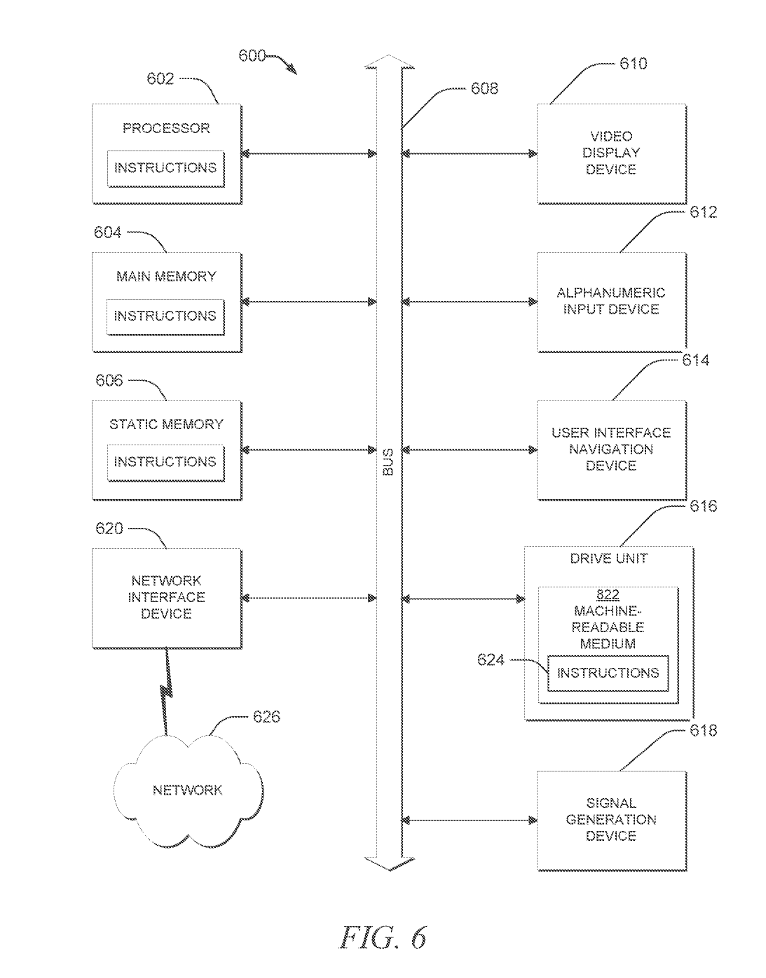

FIG. 5 is a flowchart 500 illustrating an example method, according to various embodiments.

At operation 510, the Forecasting Engine 206 receives a ranked list of content portions based on respective relevance score values of the content portions. Each relevance score value is indicative of a measure of similarity between a member account of a social network service and a content portion. In some example embodiments, a ranked list of content portions can be a listing of job posts for a particular member account in which each individual job post is associated (e.g., listed) with a respective relevance score value that represents the measure of similarity between the particular member account (e.g., member profile included in the member account) of a social network service and the respective individual job post.

At operation 520, the Forecasting Engine 206 forecasts an expected number of member account actions resulting from presentation of a content portion included in the ranked list to a given member account. In some example embodiments, the Forecasting Engine 206 identifies a time window the content portion is available for presentation in the social network service. The Forecasting Engine 206 predicts a number of member account actions for each day in the time window. The Forecasting Engine 206 generates a sum of each day's predicted number of member account actions.

To predict each day's number of member account actions that will be received in response to presenting the content portion to a plurality of member accounts, the Forecasting Engine 206 identifies a current number of member account actions already received in response to presentation of the content portion included in one or more ranked lists to a plurality of member accounts. The Forecasting Engine 206 determines a constant rate of impressions per day based on the current number of member account actions already received and a portion of the time window that has already passed. For each respective day in the time window, the Forecasting Engine 206 generates a predicted number of member account actions for the respective day based at least on the constant rate of impressions per day, an amount of time available in the respective day, and a decay rate that corresponds to the respective day.

in one embodiment, the Forecasting Engine 206 modifies the amount of time available in the respective day based on a pre-defined type of day associated with the respective day. For example, a weekend day will count as 12 hours instead of 24 hours and a weekday after Wednesday will count as 18 hours instead of 24 hours. The Forecasting Engine 206 identifies a decay rate to be applied to the constant rate of impressions per day. The decay rate corresponds to a position of the respective day in the time window. For example, a respective day's decay rate increases the closer it is to expiration of the time window.

At operation 530, the Forecasting Engine 206 modifies the content portion's relevance score value based on the expected (e.g., forecasted) number of member account actions. In some example embodiments, the Forecasting Engine 206 compares the expected number of member account actions resulting from presentation of the content portion to a confidence interval range (e.g., one or more numbers or values). The confidence interval range represents a range of an expected number member account actions resulting from presentation of any given content portion. Based on the comparison to the confidence interval range, the Forecasting Engine 206 modifies a relevance score value that corresponds to the content portion by either boosting or penalizing the relevance score value.

At operation 540, the Forecasting Engine 206 updates the ranked list of content portions based on a modified relevance score value of the content portion. If the modified relevance score value of the content portion. is boosted, then there is an increased likelihood that the content portion will be deemed relevant to more member accounts—and thereby presented in a greater number of listings of job posts to a plurality of member accounts. Such increased presentation in listings of job posts will ensure a higher chance that more member accounts will submit job applications and the total number of submitted job applications will likely be a desirable number. However, if the modified relevance score value of the content portion is penalized, then there is a decreased likelihood that the content portion will be deemed relevant to more member accounts and thereby presented in a fewer number of listings of job posts to a plurality of member accounts. Such decreased presentation in listings of job posts will ensure a lower chance that more member accounts will submit job applications and the total number of submitted job applications will likely be a desirable number.

Certain embodiments are described herein as including logic or a number of components, modules, or mechanisms. Modules may constitute either software modules (e.g., code embodied on a machine- or computer-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may he implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

FIG. 6 is a block diagram of an example computer system 600 on which operations, actions and methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also he taken to include any collection of machines that individually or jointly execute a set (or multiple sets) of instructions to perform any one or more of the methodologies discussed herein.

Example computer system 600 includes a processor 602 (e.g., a central processing unit (CPU), a graphics processing unit (GPU) or both), a main memory 604, and a static memory 606, which communicate with each other via a bus 608. Computer system 600 may further include a video display device 610 (e.g., a liquid crystal display (LCD) or a cathode ray tube (CRT)). Computer system 600 also includes an alphanumeric input device 612 (e.g., a keyboard), a user interface (UI) navigation device 614 (e.g., a mouse or touch sensitive display), a disk drive unit 616, a signal generation device 618 (e.g., a speaker) and a network interface device 620.

Disk drive unit 616 includes a machine-readable medium 622 on which is stored one or more sets of instructions and data structures (e.g., software) 624 embodying or utilized by any one or more of the methodologies or functions described herein. Instructions 624 may also reside, completely or at least partially, within main memory 604, within static memory 606, and/or within processor 602 during execution thereof by computer system 600, main memory 604 and processor 602 also constituting machine-readable media.

While machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any, tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and. magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 624 may further be transmitted or received over a communications network 626 using a transmission medium. Instructions 624 may be transmitted using network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data. networks (e.g., WiFi and WiMAX networks). The term “transmission. medium” shall be taken to include any intangible medium that is capable of storing, encoding or carrying instructions for execution by the machine, and includes digital or analog communications signals or other intangible media to facilitate communication of such software.

Although an embodiment has been described with reference to specific, example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer system, comprising:
one or more hardware processors; and
a machine-readable medium for storing instructions that, when executed by the one or more hardware processors of a machine, cause the machine to perform operations comprising:
receiving a ranked list of content portions, the content portions being ranked based on respective relevance score values of the content portions, each relevance score value being indicative of a measure of similarity between a member account of a social network service and a content portion;
forecasting an expected number of member account actions resulting from presentation of a content portion included in the ranked list to a given member account;
modifying the relevance score value of the content portion based on the expected number of member account actions;
updating the ranked list of content portions based on a modified relevance score value of the content portion, the updating resulting in an updated ranked list of content portions; and
generating and causing a display of a user interface on a client device, the user interface presenting the updated ranked list of content portions.

2. The computer system of claim 1, wherein the forecasting of the expected number of member account actions resulting from presentation of the content portion included in the ranked list to the given member account comprises:
identifying a time window the content portion is available for presentation in the social network service;
predicting a number of member account actions for each day in the time window; and
generating a sum of each day's predicted number of member account actions.

3. The computer system of claim 2, wherein predicting the number of member account actions for each day in the time window comprises:
identifying a current number of member account actions already received in response to presentation of the content portion in one or more ranked lists to a plurality of member accounts;
determining a constant rate of impressions per day based on the current number of member account actions already received and a portion of the time window that has already passed; and
for each respective day in the time window, generating a predicted number of member account actions for the respective day based at least on the constant rate of impressions per day, an amount of time available in the respective day and a decay rate that corresponds to the respective day.

4. The computer system of claim 3, wherein the operations further comprise:
for each respective day in the time window:
modifying the amount of time available in the respective day based on a pre-defined type of day associated with the respective day; and
identifying a decay rate to be applied to the constant rate of impressions per day, the decay rate corresponding to a. position of the respective day in the time window.

5. The computer system of claim 1, wherein the operations further comprise:
comparing the expected number of member account actions resulting from presentation of the content portion to a confidence interval range, the confidence interval range representing a range of an expected number member account actions resulting from presentation of any given content portion; and
based on the comparison to the confidence interval range, modifying a relevance score value that corresponds to the content portion.

6. The computer system of claim 5, wherein the modifying of the relevance score value that corresponds to the content portion comprises:
in response to determining the expected number of member account actions resulting from presentation of the content portion exceeds the confidence interval range, penalizing the job post by decreasing the relevance score value.

7. The computer system of claim 5, wherein the modifying of the relevance score value that corresponds to the content portion comprises:
in response to determining the expected number of member account actions resulting from presentation of the content portion does not meet a minimum of confidence interval range, boosting the job post by increasing the relevance score value.

8. The computer system of claim 1, wherein each content portion is a particular job post, and each member account action is an application, received from a respective member account, for a job represented by the particular job post.

9. A computer-implemented method comprising:
receiving a ranked list of content portions, the content portions being ranked based on respective relevance score values of the content portions, each relevance score value being indicative of a measure of similarity between a member account of a social network service and a content portion;
forecasting, using one or more hardware processors, an expected number of member account actions resulting from presentation of a content portion included in the ranked list to a given member account;
modifying the relevance score value of the content portion based on the expected number of member account actions;
updating the ranked list of content portions based on a modified relevance score value of the content portion, the updating resulting in an updated ranked list of content portions; and
generating and causing a display of a user interface on a client device, the user interface presenting the updated ranked list of content portions.

10. The computer-implemented method of claim 9, wherein the forecasting of the expected number of member account actions resulting from presentation of the content portion included in the ranked list to the given member account comprises:
identifying a time window the content portion is available for presentation in the social network service;
predicting a number of member account actions for each day in the time window; and
generating a sum of each day's predicted number of member account actions.

11. The computer-implemented method of claim 10, wherein the predicting of the number of member account actions for each day in the time window comprises:
identifying, a current number of member account actions already received in response to presentation of the content portion in one or more ranked lists to a plurality of member accounts;
determining a constant rate of impressions per day based on the current number of member account actions already received and a portion of the time window that has already passed; and
for each respective day in the time window, generating a predicted number of member account actions for the respective day based at least on the constant rate of impressions per day, an amount of time available in the respective day and a decay rate that corresponds to the respective day.

12. The computer-implemented method of claim 11, further comprising:
for each respective day in the time window:
modifying the amount of time available in the respective day based on a pre-defined type of day associated with the respective day; and
identifying a decay rate to be applied to the constant rate of impressions per day, the decay rate corresponding to a position of the respective day in the time window.

13. The computer-implemented method of claim 9, further comprising:
comparing the expected number of member account actions resulting from presentation of the content portion to a confidence interval range, the confidence interval range representing a range of an expected number member account actions resulting from presentation of any given content portion; and
based on the comparison to the confidence interval range, modifying a relevance score value that corresponds to the content portion.

14. The computer-implemented method of claim 13, wherein the modifying of the relevance score value that corresponds to the content portion comprises:
in response to determining the expected number of member account actions resulting from presentation of the content portion exceeds the confidence interval range, penalizing the job post by decreasing the relevance score value.

15. The computer-implemented method of claim 13, wherein the modifying of the relevance score value that corresponds to the content portion comprises:
in response to determining the expected number of member account actions resulting from presentation of the content portion does not meet a minimum of confidence interval range, boosting the job post by increasing the relevance score value.

15. The computer-implemented method of claim 9, wherein each content portion is a particular job post, and each member account action is an application, received from a respective member account, for a job represented by the particular job post.

17. A non-transitory computer-readable medium comprising instructions that, when executed by one or more hardware processors of a machine, cause the machine to perform operations comprising:
receiving a ranked list of content portions, the content portions being ranked based on respective relevance score values of the content portions, each relevance score value being indicative of a measure of similarity between a member account of a social network service and a content portion;
forecasting an expected number of member account actions resulting from presentation of a content portion included in the ranked list to a given member account;
modifying the relevance score value of the content portion based on the expected number of member account actions;
updating the ranked list of content portions based on a modified relevance score value of the content portion, the updating resulting in an updated ranked list of content portions; and
generating and causing a display of a user interface on a client device, the user interface presenting the updated ranked list of content portions.

18. The non-transitory computer-readable medium of claim 17, wherein the forecasting of the expected number of member account actions resulting from presentation of the content portion included in the ranked list to the given member account comprises:
identifying a time window the content portion is available for presentation in the social network service;
predicting a number of member account actions for each day in the time window; and
generating a sum of each day's predicted number of member account actions.

19. The non-transitory computer-readable medium claim 18, wherein the predicting of the number of member account actions for each day in the time window comprises:
identifying a current number of member account actions already received in response to presentation of the content portion in one or more ranked lists to a plurality of member accounts;
determining a constant rate of impressions per day based on the current number of member account actions already received and a portion of the time window that has already passed; and
for each respective day in the time window, generating a predicted number of member account actions for the respective day based at least on the constant rate of impressions per day, an amount of time available in the respective day and a decay rate that corresponds to the respective day.

20. The non-transitory computer-readable medium of claim 19, wherein the operations further comprise:
for each respective day in the time window:
modifying the amount of time available in the respective day based on a pre-defined type of day associated with the respective day; and
identifying a decay rate to be applied to the constant rate of impressions per day, the decay rate corresponding to a position of the respective day in the time window.
